(19) United States
(12) Patent Application Publication
(10) Pub. No.: US 2026/0268569 A1
(43) Pub. Date: Sep. 10, 2026

(54) METHOD FOR GENERATING AND PRESENTING PUSHED CONTENT, APPARATUS, MEDIUM DEVICE, AND PRODUCT

(71) Applicant: Beijing Youzhuju Network Technology Co., Ltd., Pinggu District (CN)

(72) Inventors: Xinyu Sun, Beijing (CN); Han Song, Beijing (CN); Yining Wang, Beijing (CN); Shengyan Shi, Beijing (CN); Linyang Li, Beijing (CN); Junquan Zeng, Beijing (CN)

(21) Appl. No.: 19/459,968

(22) Filed: Jan. 26, 2026

(30) Foreign Application Priority Data
Mar. 7, 2025 (CN) 202510273151.2

(51) Int. Cl. G06T 13/40; A63F 13/55; G06T 13/20

(52) U.S. Cl. CPC G06T 13/40; A63F 13/55; G06T 13/205

(57) ABSTRACT

A method for generating and presenting pushed content, apparatuses, a medium device, and a product. The method includes determining, in response to receiving a content acquisition request from a client, a user feature associated with the content acquisition request; determining, based on the user feature, a content material to be pushed; determining, based on the user feature, target style configuration information, a target virtual character animation, and target interaction configuration information; and sending a pushed data package including the content material, the target style configuration information, the target virtual character animation, and the target interaction configuration information to the client, so that the client performs, based on the pushed data package, content presentation, and performs, based on the presented target interaction component and the target interaction rule, interactive guidance for a user of the client.

### CROSS-REFERENCE TO RELATED APPLICATION(S)

This application claims priority to Chinese Application No. 202510273151.2 filed Mar. 07, 2025, the disclosure of which is incorporated herein by reference in its entirety.

### FIELD

The present disclosure relates to the field of computer technologies, and specifically, to a method for generating pushed data, a method for presenting pushed data, an apparatus, a medium device, and a product.

### BACKGROUND

At present, a client may be used to provide a user with pushed content associated with reward information, and copy may be used to provide interactive guidance to the user, to help the user obtain a corresponding reward. However, the pushed content is usually presented statically, which leads to a poor browsing experience of the user. In addition, when the user is provided with interactive guidance, guidance copy usually covers an upper layer of the pushed content, which affects presentation of the pushed content, and results in that the user cannot have enough understanding of the pushed content.

### SUMMARY

The Summary section is provided to briefly introduce concepts, which will be described in detail later in the Detailed Description section. The Summary section is not intended to identify key features or essential features of the claimed technical solutions, nor is it intended to limit the scope of the claimed technical solutions.

In a first aspect, the present disclosure provides a method for generating pushed content, applied to a content push platform, wherein the method includes:

determining, in response to receiving a content acquisition request from a client, a user feature associated with the content acquisition request;

determining, based on the user feature, a content material to be pushed;

determining, based on the user feature, target style configuration information, a target virtual character animation, and target interaction configuration information, wherein the target interaction configuration information is used for configuring a target interaction component and a target interaction rule, and the target interaction component is used for being presented in association with the target virtual character animation; and

sending a pushed data package including the content material, the target style configuration information, the target virtual character animation, and the target interaction configuration information to the client, so that the client performs, based on the pushed data package, content presentation, and performs, based on the presented target interaction component and the target interaction rule, interactive guidance for a user of the client.

In a second aspect, the present disclosure provides a method for presenting pushed content, applied to a client, wherein the method includes:

sending a content acquisition request to a content push platform;

receiving a pushed data package sent by the content push platform, wherein the pushed data package includes a content material, target style configuration information, a target virtual character animation, and target interaction configuration information, the target interaction configuration information is used for configuring a target interaction component and a target interaction rule, and the target interaction component is used for being presented in association with the target virtual character animation;

presenting, based on the target style configuration information, the content material, the target virtual character animation, and the target interaction component; and

performing, based on the target interaction component and the target interaction rule, interactive guidance for a user of the client.

In a third aspect, the present disclosure provides an apparatus for generating pushed content, applied to a content push platform, wherein the apparatus includes:

a first determination module, configured to determine, in response to receiving a content acquisition request from a client, a user feature associated with the content acquisition request;

a second determination module, configured to determine, based on the user feature, a content material to be pushed;

a third determination module configured to determine, based on the user feature, target style configuration information, a target virtual character animation, and target interaction configuration information, wherein the target interaction configuration information is used for configuring a target interaction component and a target interaction rule, and the target interaction component is used for being presented in association with the target virtual character animation; and

a first sending module, configured to send a pushed data package including the content material, the target style configuration information, the target virtual character animation, and the target interaction configuration information to the client, so that the client performs, based on the pushed data package, content presentation and performs, based on the presented target interaction component and the target interaction rule, interactive guidance for a user of the client.

In a fourth aspect, the present disclosure provides an apparatus for generating pushed content, applied to a client, wherein the apparatus includes:

a second sending module, configured to send a content acquisition request to a content push platform;

a receiving module, configured to receive a pushed data package sent by the content push platform, wherein the pushed data package includes a content material, target style configuration information, a target virtual character animation, and target interaction configuration information, the target interaction configuration information is used for configuring a target interaction component and a target interaction rule, and the target interaction component is used for being presented in association with the target virtual character animation;

a presentation module, configured to present, based on the target style configuration information, the content material, the target virtual character animation, and the target interaction component; and

an interactive guidance module, configured to perform, based on the target interaction component and the target interaction rule, interactive guidance for a user of the client.

In a fifth aspect, the present disclosure provides a computer-readable medium having a computer program stored thereon, wherein the computer program, when executed by a processor, causes the processor to perform the steps of the method according to the first aspect or the second aspect of the present disclosure.

In a sixth aspect, the present disclosure provides an electronic device, and the electronic device includes:

a memory, having a computer program stored thereon; and

a processor, configured to execute the computer program in the memory to implement steps of the method according to the first aspect or the second aspect of the present disclosure.

In a seventh aspect, the present disclosure provides a computer program product, which includes a computer program, wherein the computer program, when executed by a processor, implements steps of the method according to the first aspect or the second aspect of the present disclosure.

The other features and advantages of the present disclosure will be described in detail in the following Detailed Description section.

### BRIEF DESCRIPTION OF THE DRAWINGS

The above and other features, advantages, and aspects of the embodiments of the present disclosure will become more apparent in combination with the drawings and with reference to the following Detailed Description section. Throughout the drawings, the same or similar reference numbers refer to the same or similar elements. It should be understood that the drawings are schematic, and that parts and elements are not necessarily drawn to scale. In the drawings:

FIG. 1 is a flowchart of a method for generating pushed content according to an implementation of the present disclosure;

FIG. 2 is an exemplary schematic diagram of a presentation effect configured via target style configuration information in the present disclosure;

FIG. 3 is an exemplary schematic diagram of a presentation effect in the present disclosure;

FIG. 4 is a flowchart of a method for presenting pushed content according to an implementation of the present disclosure;

FIG. 5 is a schematic flowchart of a possible process in an application scenario of the present disclosure;

FIG. 6 is a block diagram of an apparatus for generating pushed content according to an implementation of the present disclosure;

FIG. 7 is a block diagram of an apparatus for presenting pushed content according to an implementation of the present disclosure; and

FIG. 8 shows a schematic structural diagram of an electronic device suitable for implementing the embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein. Instead, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the steps described in the method implementations of the present disclosure may be performed in different orders, and/or performed in parallel. In addition, the method implementations may include additional steps and/or omit the steps shown. The scope of the present disclosure is not limited in this respect.

The term "include/comprise" and its variants used herein are open-ended inclusions, that is, "include/comprise but not limited to". The term "based on" is "based at least partially on". The term "an embodiment" means "at least one embodiment". The term "another embodiment" means "at least one other embodiment". The term "some embodiments" means "at least some embodiments". Related definitions of other terms will be given in the following description.

It should be noted that the concepts such as "first" and "second" mentioned in the present disclosure are only used to distinguish different apparatuses, modules, or units, and are not used to limit the order or interdependence of the functions performed by these apparatuses, modules, or units.

It should be noted that the modifications of "a" and "a plurality of" mentioned in the present disclosure are exemplary rather than restrictive. Those skilled in the art should understand that unless otherwise clearly indicated in the context, they should be understood as "one or more".

The names of messages or information exchanged between a plurality of apparatuses in the implementations of the present disclosure are only used for illustrative purposes, and are not used to limit the scope of these messages or information.

It may be understood that before the technical solutions disclosed in the embodiments of the present disclosure are used, the user should be informed of the type, range of use, use scenarios, etc., of personal information involved in the present disclosure in an appropriate manner according to relevant laws and regulations, and the authorization of the user should be obtained.

For example, in response to receiving an active request from a user, prompt information is sent to the user, to clearly prompt the user that the requested operation will require access to and use of the personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to "agree" or "disagree" to provide the personal information to the electronic device.

It may be understood that the above process of notifying the user and acquiring the authorization of the user is only exemplary, and does not constitute a limitation on the implementations of the present disclosure. Other manners that satisfy the relevant laws and regulations may also be applied in the implementations of the present disclosure.

In addition, it may be understood that the data involved in the technical solution (including but not limited to the data itself, acquisition of the data, or use of the data) shall comply with the requirements of the corresponding laws, regulations, and related provisions.

As described in the Background section, at present, in the manner in which the pushed content associated with the reward information is provided to the user through the client and the user is provided with interactive guidance through the copy, the static presentation of the pushed content leads to a poor browsing experience of the user, and the coverage of the pushed content by the guidance copy affects the presentation of the pushed content, resulting in that the user cannot have enough understanding of the pushed content. For example, in a video incentive advertisement scenario, the user needs to watch an advertisement of a fixed duration to obtain a reward, but the static presentation is too long, which leads to poor user experience. For another example, an interactive advertisement provides copy and gesture guidance, but when presented, the interactive advertisement covers an upper layer of the material, and the presentation form is relatively rigid, and the presentation of the material may also be affected, resulting in poor user experience.

To solve the above technical problem, the present disclosure provides a method for generating pushed content, a method for presenting pushed content, apparatuses, a medium device, and a product.

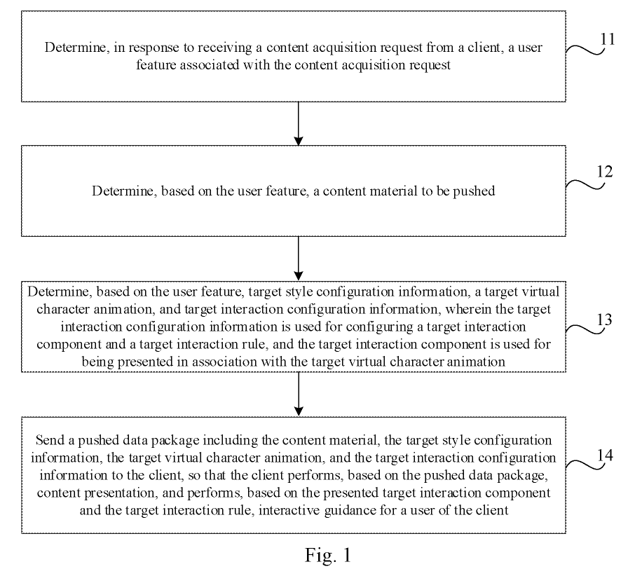

FIG. 1 is a flowchart of a method for generating pushed content according to an implementation of the present disclosure. The method for generating pushed content provided in the present disclosure may be applied to a content push platform (or a content push server). Generally, after receiving a content acquisition request from a client, the content push platform may select the most appropriate content material, and return the content material to the client in combination with style configuration, to enable the client to perform presentation. Exemplarily, if the content push platform is an advertisement platform, after receiving the content acquisition request, the advertisement platform may select the most appropriate advertisement, then select an appropriate advertisement style, package the advertisement and the advertisement style, and return them to the client, to enable the client to present the advertisement.

As shown in FIG. 1, the method for generating pushed content provided in the present disclosure may include steps 11 to 14.

In step 11, a user feature associated with a content acquisition request is determined in response to receiving the content acquisition request from a client.

Optionally, the content acquisition request may carry identification information (for example, a device identifier or a user identifier) for uniquely identifying a user who triggers the content acquisition request. Based on the content acquisition request, a corresponding user feature may be determined in an existing feature database according to the identification information.

Exemplarily, taking the pushed content as an advertisement for an example, after the content acquisition request is acquired, the user feature may be acquired in a DMP (Data Management Platform) according to the identification information.

In step 12, a content material to be pushed is determined based on the user feature.

According to the user feature, the content material to be pushed that is determined for the current content acquisition request may be determined, based on a preset content material selection manner, from an optional content material in a material library. The content material selection manner may be flexibly set based on an actual requirement.

Exemplarily, taking the pushed content as an advertisement for an example, several advertisements suitable for being pushed may be determined based on the user feature, and then an advertisement with a highest bid is determined, based on respective bid of these advertisements, as the advertisement to be pushed.

In step 13, target style configuration information, a target virtual character animation, and target interaction configuration information are determined based on the user feature, wherein the target interaction configuration information is used for configuring a target interaction component and a target interaction rule, and the target interaction component is used for being presented in association with the target virtual character animation.

Optionally, the content push platform may be preset with a plurality of pieces of style configuration information, a plurality of virtual character animations, and a plurality of pieces of interaction configuration information. Based on the user feature, the target style configuration information, the target virtual character animation, and the target interaction configuration information may be determined from the plurality of pieces of style configuration information, the plurality of virtual character animations, and the plurality of pieces of interaction configuration information.

The style configuration information, the virtual character animation, and the interaction configuration information involved in the present disclosure are described below, respectively.

The style configuration information is used for specifying a presentation form of content, and is used for configuring a material, a button, a layout, an animation, an interaction, etc., to form an overall visual and auditory effect of the content. The style configuration information may include a layout parameter, a visual parameter, an adaptation rule, a resource reference, etc. The layout parameter may include a position, a size, a hierarchical relationship, a screen partitioning rule, etc., of each element (for example, the content material, the virtual character animation, the target interaction component, and other components) included in the content to be presented. The visual parameter may include a font style, a color, transparency, etc. The adaptation rule may include a dynamic adjustment strategy (for example, a responsive layout and scaling) for different resolutions of the client. The resource reference may include a reference manner of the content material, the virtual character animation, and a component, etc., such as a location of the content material, an identifier of the virtual character animation, and a button icon.

The virtual character animation is an animation based on a virtual character, and is usually represented as that the virtual character makes a series of actions. Exemplarily, the virtual character may be an AI (Artificial Intelligence) digital human. Optionally, a virtual character database may be set in the present disclosure for storing virtual character animations, and each virtual character animation is distinguished by a virtual character identifier.

To construct the virtual character database, a plurality of original images or videos with a person (or other images) may be acquired, and then a person part is extracted from the original images or videos, and a person animation is formed based on different postures of the person, to serve as the virtual character animation. Optionally, the virtual character animation may also correspond to a character feature, which may be carried by the original person or marked. Exemplarily, the character feature may include copyright time, gender, age, country, style, occupation, etc.

The interaction configuration information may configure an interaction component that needs to be presented in association with the virtual character animation, and is also used for configuring a corresponding interaction rule, to provide an available interactive gameplay for the user in an interactive region formed by the virtual character animation and the interaction component. For example, in an interactive gameplay of a lottery, the interaction configuration information needs to configure a whole set of lottery process based on the interaction component of a lottery turntable. In other words, the interaction configuration information is used for defining a rule set of user operation behavior and corresponding feedback logic, and controlling a dynamic response mechanism of the pushed content, to implement instant interaction, thereby improving the participation of the user.

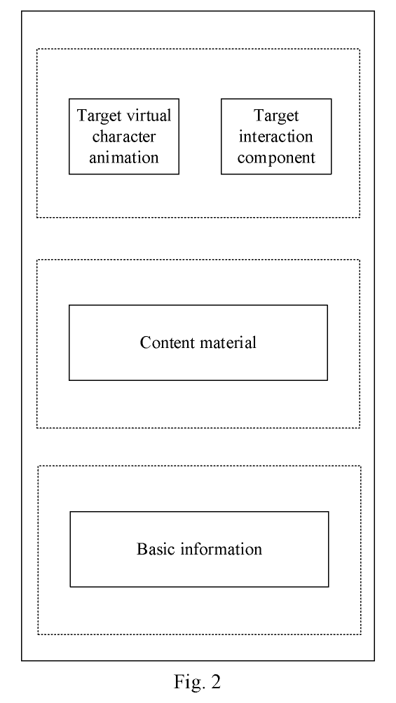

Exemplarily, the presentation effect configured via the target style configuration information may be as shown in FIG. 2. The layout is mainly divided into three regions. The upper region is used for presenting the target virtual character animation and the target interaction component, the middle region is used for presenting the content material, and the lower region is used for presenting basic information (for example, a conversion button of an advertisement).

As mentioned above, the plurality of pieces of style configuration information, the plurality of virtual character animations, and the plurality of pieces of interaction configuration information are pre-stored in the content push platform, therefore, appropriate style configuration information, virtual character animation, and interaction configuration information need to be selected from them for the current content acquisition request.

In a possible implementation, one piece of style configuration information, one virtual character animation, and one piece of interaction configuration information may be randomly selected, respectively, from the stored style configuration information, the stored virtual character animations, and the stored interaction configuration information, as the target style configuration information, the target virtual character animation, and the target interaction configuration information.

In another possible implementation, one piece of style configuration information, one virtual character animation, and one piece of interaction configuration information may be randomly selected, respectively, from style configuration information, virtual character animations, and interaction configuration information that have best historical presentation effects, as the target style configuration information, the target virtual character animation, and the target interaction configuration information, based on historical presentation effects of the stored style configuration information, the stored virtual character animations, and the stored interaction configuration information. The historical presentation effect may be measured by setting a quantification indicator. Exemplarily, the historical presentation effect may be reflected by a click-through rate, and the best historical presentation effect may be a highest click-through rate.

In another possible implementation, the target style configuration information may be determined by:

acquiring the plurality of pieces of style configuration information stored;

predicting, for each piece of the style configuration information, and based on the user feature, the content material, and the style configuration information, an interaction effect during presentation of the style configuration information, to obtain a first prediction result; and

determining, based on the first prediction result and a first interaction effect requirement, style configuration information with a highest matching degree with the first interaction effect requirement, as the target style configuration information.

Optionally, the interaction effect may be a quantification standard used for measuring an interaction condition between a user and the presented pushed content, and may be set based on an actual requirement. Exemplarily, a click-through rate, a conversion rate, etc., may be selected as the interaction effect.

The prediction of the interaction effect when the style configuration information is presented may be implemented by a pre-generated model.

Exemplarily, for each piece of style configuration information, a first historical user feature and first historical content material that respectively correspond to first historical pushed content presented in a style indicated by the style configuration information may be used, and a first historical interaction effect after each piece of historical pushed content is actually presented is collected, to obtain a plurality of groups of first training samples. Each group of first training samples includes a group of style configuration information, a first historical user feature, a first historical content material, and a first historical interaction effect. Then, the first historical user feature, the first historical content material, and the style configuration information of each group are used as input of the model, and the first historical interaction effect of the group is used as target output of the model, to train the machine learning model, to obtain a first prediction model that has been trained.

The trained first prediction model has an ability of predicting an interaction effect based on a user feature, a content material, and style configuration information. In this way, by inputting the user feature, the content material, and the style configuration information into the first prediction model, the first prediction result output by the model may be obtained.

Further, based on the first prediction result and the first interaction effect requirement, the style configuration information with the highest matching degree with the first interaction effect requirement may be determined, as the target style configuration information.

The first interaction effect requirement may be flexibly set based on an actual requirement. If the interaction effect is a quantification indicator K1, the first interaction effect may be set as the quantification indicator K1 reaching a specified value. Exemplarily, if a click-through rate is selected as the interaction effect, the first interaction effect requirement may be a highest click-through rate, or a click-through rate of X (a set value). In this way, style configuration information with a highest predicted click-through rate, or style configuration information with a predicted click-through rate closest to X may be selected as the target style configuration information.

In another possible implementation, the target virtual character animation may be determined by:

acquiring a character feature corresponding to each of a plurality of virtual character animations stored;

predicting, for each of the virtual character animations, and based on the user feature, the content material, and the character feature corresponding to the virtual character animation, an interaction effect during presentation of the virtual character animation, to obtain a second prediction result; and

determining, based on the second prediction result and a second interaction effect requirement, a virtual character animation with a highest matching degree with the second interaction effect requirement, as the target virtual character animation.

The prediction of the interaction effect when the virtual character animation is presented may be implemented by a pre-generated model. Exemplarily, for each virtual character animation, a second historical user feature and second historical content material that respectively correspond to second historical pushed content including the presented virtual character animation may be used, and a second historical interaction effect after each piece of second historical pushed content is actually presented is collected, to obtain a plurality of groups of second training samples. Each group of second training samples includes a character feature corresponding to a group of virtual character animations, a second historical user feature, a second historical content material, and a second historical interaction effect. Then, the character feature corresponding to the virtual character animation, the second historical user feature, and the second historical content material of each group are used as input of the model, and the second historical interaction effect of the group is used as target output of the model, to train the machine learning model, to obtain a second prediction model that has been trained.

The trained second prediction model has an ability of predicting an interaction effect based on a user feature, a content material, and a character feature corresponding to a virtual character animation. In this way, by inputting the user feature, the content material, and the character feature corresponding to the virtual character animation into the second prediction model, the second prediction result output by the model may be obtained.

Further, based on the second prediction result and the second interaction effect requirement, a virtual character animation with a highest matching degree with the second interaction effect requirement may be determined, as the target virtual character animation.

The second interaction effect requirement may be flexibly set based on an actual requirement. If the interaction effect is a quantification indicator K2, the second interaction effect may be set as the quantification indicator K2 reaching a specified value. Exemplarily, if a click-through rate is selected as the interaction effect, the second interaction effect requirement may be a highest click-through rate, or a click-through rate of Y (a set value). In this way, a virtual character animation with a highest predicted click-through rate, or a virtual character animation with a predicted click-through rate closest to Y may be selected as the target virtual character animation.

In another possible implementation, the target interaction configuration information may be determined by:

acquiring a plurality of pieces of interaction configuration information stored, wherein each piece of the interaction configuration information includes attribute information of an interaction component and an interaction rule;

predicting, for each piece of the interaction configuration information, and based on the user feature, the content material, and the interaction configuration information, an interaction effect of the interaction configuration information, to obtain a third prediction result; and

determining, based on the third prediction result and a third interaction effect requirement, interaction configuration information with a highest matching degree with the third interaction effect requirement, as the target interaction configuration information.

The prediction of the interaction effect of the interaction configuration information may be implemented by a pre-generated model. Exemplarily, for each piece of interaction configuration information, a third historical user feature and a third historical content material that respectively correspond to third historical pushed content based on the interaction configuration information may be used, and a third historical interaction effect after each piece of third historical pushed content is actually presented is collected, to obtain a plurality of groups of third training samples. Each group of third training samples includes a group of third historical user features, a third historical content material, interaction configuration information, and a third historical interaction effect. Then, the third historical user feature, the third historical content material, and the interaction configuration information of each group are used as input of the model, and the third historical interaction effect of the group is used as target output of the model, to train the machine learning model, to obtain a third prediction model that has been trained.

The trained third prediction model has an ability of predicting an interaction effect based on a user feature, a content material, and interaction configuration information. In this way, by inputting the user feature, the content material, and the interaction configuration information into the third prediction model, the third prediction result output by the model may be obtained.

Further, based on the third prediction result and the third interaction effect requirement, the interaction configuration information with the highest matching degree with the third interaction effect requirement may be determined, as the target interaction configuration information.

The third interaction effect requirement may be flexibly set based on an actual requirement. If the interaction effect is a quantification indicator K3, the third interaction effect may be set as the quantification indicator K3 reaching a specified value. Exemplarily, if a conversion rate is selected as the interaction effect, the third interaction effect requirement may be a highest conversion rate, or a conversion rate of Z (a set value). In this way, interaction configuration information with a highest predicted conversion rate, or interaction configuration information with a predicted conversion rate closest to Z may be selected as the target interaction configuration information.

According to the above method, the style configuration information, the virtual character animation, and the interaction configuration information may be respectively selected and optimized, to improve the overall presentation effect when the content to be pushed is presented.

In step 14, a pushed data package including the content material, the target style configuration information, the target virtual character animation, and the target interaction configuration information is sent to the client, so that the client performs, based on the pushed data package, content presentation, and performs, based on the presented target interaction component and the target interaction rule, interactive guidance for a user of the client.

According to the above technical solution, after the content acquisition request from the client is received, the content material to be pushed may be determined based on the user feature associated with the content acquisition request, and the corresponding target style configuration information, the corresponding target virtual character animation, and the corresponding target interaction configuration information are determined, to form the pushed data package, which is sent to the client, so that the client may perform corresponding content presentation, and may also perform interactive guidance on the user based on the presented target interaction component and the target interaction rule. In this way, the virtual character animation is introduced on the basis of the content material, to provide richer dynamic effects for the content material, which is favorable for improving the browsing effect of the user on the content material during presentation. In addition, based on the pushed data package, the content material, the virtual character, and the target interaction component may be presented together on a screen, and there is no possibility of mutual coverage. During presentation, the user may be provided with diverse information synchronously through multiple channels, to improve the browsing willingness of the user.

After the target style configuration information, the target virtual character animation, and the target interaction configuration information are determined, the content material, the target style configuration information, the target virtual character animation, and the target interaction configuration information may be packaged into the pushed data package and sent to the client, to enable the client to perform presentation.

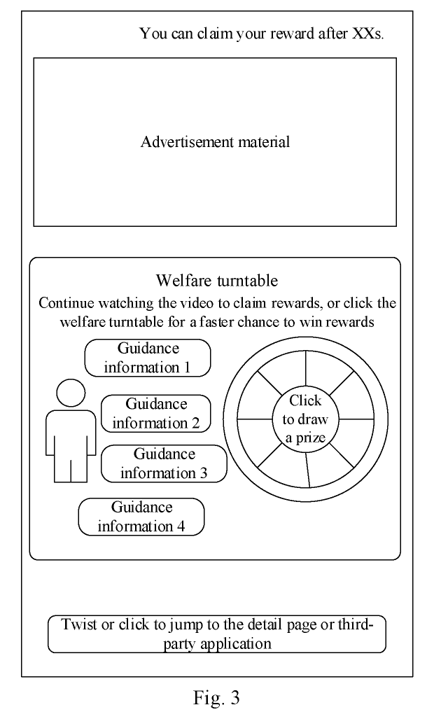

Exemplarily, if the pushed content is an advertisement, the presentation effect may be as shown in FIG. 3, wherein the pushed content is presented in three regions, namely, upper, middle, and lower regions. The advertisement material (the content material) is presented in the upper region, the digital human animation (the target virtual character animation) and the lottery turntable (the target interaction component) are presented in the middle region, the digital human animation and the lottery turntable are presented separately on left and right sides, and the conversion button (the advertisement basic information) is presented in the lower region. Meanwhile, text guidance information may be presented near the digital human, and the text guidance information may be presented based on the setting of the target style configuration information, for example, presented sequentially at a certain time interval.

In another possible implementation, the content material may be associated with a target content identifier, and the target virtual character animation may correspond to a target character feature. On the basis of the steps shown in FIG. 1, the method provided in the present disclosure may further include the following steps:

a plurality of audios corresponding to the target content identifier are acquired from a preset audio database in response to determining that the content material does not include audio information;

a target audio matching a timber of the target character feature is determined from the plurality of audios; and

the target audio is added to the pushed data package, so that the client plays the target audio during presentation of the target virtual character animation.

If the content material includes audio information (for example, the content material is a video with audio), the audio information is played when the content material is presented on the client. If the content material does not include audio information (for example, the content material is a picture or a video without audio), the content material is presented silently when presented on the client, which easily leads to poor browsing experience of the user. Therefore, certain processing may be performed when the content material does not include audio information.

In the case where it is determined that the content material does not include audio information, the plurality of audios corresponding to the target content identifier may be acquired from the preset audio database.

The preset audio database may store a plurality of audios, wherein each audio is associated with one content identifier, the same content identifier corresponds to the same content material, and the same content identifier may be associated with a plurality of audios.

Exemplarily, the plurality of audios corresponding to the target content identifier may be generated by:

acquiring content description information corresponding to the target content identifier; and

performing, based on a plurality of preset timbres, text-to-audio processing on the content description information, to obtain an audio corresponding to each preset timbre.

The content description information may play a role of introducing the content material. Exemplarily, if the pushed content is an advertisement, the content description information may be an advertisement recommendation or basic information of the advertisement.

The preset timbre may be flexibly set according to an actual requirement. Exemplarily, the preset timbre may be set to include an adult male and an adult female. Exemplarily, spoken audios respectively corresponding to the plurality of preset timbres may be generated based on the content description information.

In a similar manner, a plurality of audios respectively corresponding to each content identifier may be generated, and these audios are stored in the audio database.

Therefore, the plurality of audios corresponding to the target content identifier may be acquired from the preset audio database, and then the target audio matching the timbre of the target character feature may be determined from the plurality of audios. Exemplarily, if the target character feature is a female at the age of 30, an audio with a preset timbre of an adult female may be selected, from the plurality of audios corresponding to the target content identifier, as the target audio.

The target audio may be added to the pushed data package, to enable the client to play the target audio when presenting the target virtual character animation, thereby improving the browsing experience of the user.

Exemplarily, in the case where the content material includes audio, as shown in FIG. 3, the guidance information may be presented while presenting the digital human animation. For another example, in the case where the content material does not include audio, the target audio generated based on the guidance information (the guidance information is used as the content description information) may be played while presenting the digital human animation, and the guidance information may or may not be presented on a screen.

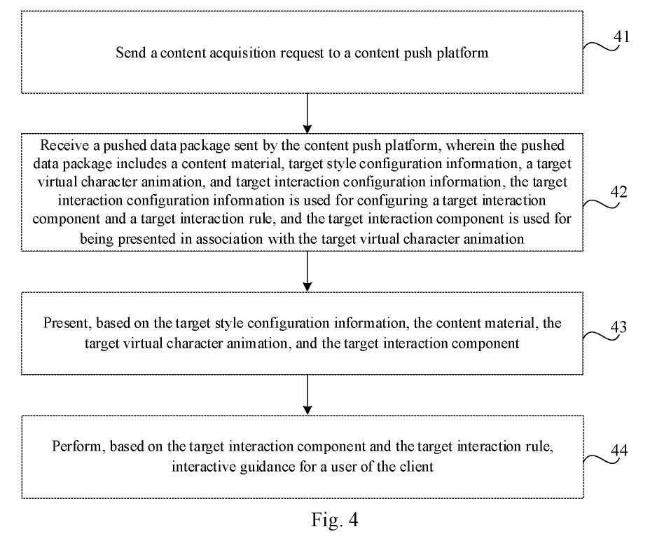

FIG. 4 is a flowchart of a method for presenting pushed content according to an implementation of the present disclosure. The method for presenting pushed content provided in the present disclosure may be applied to a client.

As shown in FIG. 4, the method for presenting pushed content may include steps 41 to 44.

In step 41, a content acquisition request is sent to a content push platform.

In step 42, a pushed data package sent by the content push platform is received, wherein the pushed data package includes a content material, target style configuration information, a target virtual character animation, and target interaction configuration information, the target interaction configuration information is used for configuring a target interaction component and a target interaction rule, and the target interaction component is used for being presented in association with the target virtual character animation.

In step 43, the content material, the target virtual character animation, and the target interaction component are presented based on the target style configuration information.

In step 44, interactive guidance is performed for a user of the client based on the target interaction component and the target interaction rule.

Exemplarily, the presentation result of the client may be as shown in FIG. 3.

According to the above method, the content material, the virtual character, and the target interaction component may be presented together on a screen, and there is no possibility of mutual coverage. During presentation, the user may be provided with diverse information synchronously through multiple channels, to improve the browsing willingness of the user.

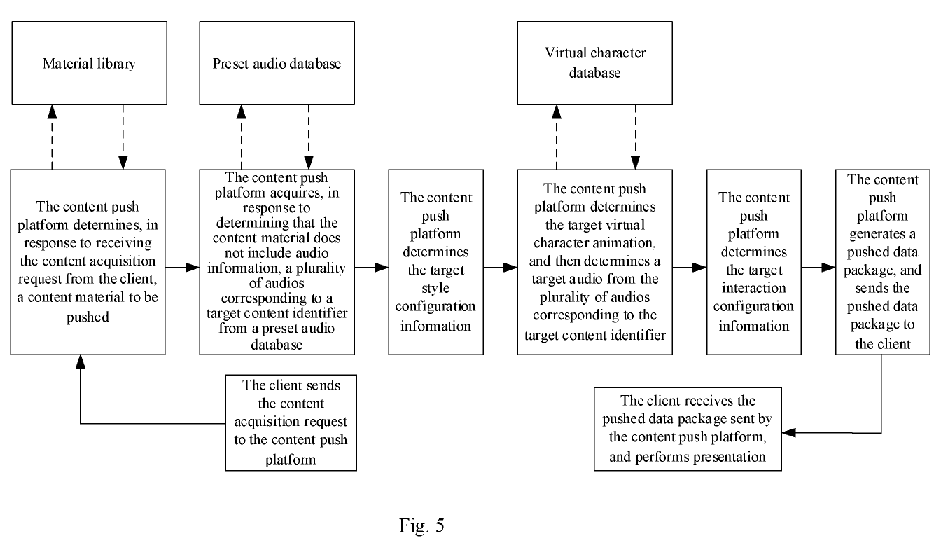

FIG. 5 is a schematic flowchart of a possible process in an application scenario of the present disclosure. In FIG. 5:

the client sends the content acquisition request to the content push platform;

the content push platform determines, in response to receiving the content acquisition request from the client, a content material to be pushed wherein the content material to be pushed may be determined from an optional content material in a material library;

the content push platform acquires, in response to determining that the content material does not include audio information, a plurality of audios corresponding to a target content identifier from a preset audio database;

the content push platform determines the target style configuration information;

the content push platform determines the target virtual character animation, and then determines a target audio from the plurality of audios corresponding to the target content identifier, wherein the target virtual character animation may be determined from a virtual character database;

the content push platform determines the target interaction configuration information;

the content push platform generates a pushed data package, and sends the pushed data package to the client; and

the client receives the pushed data package sent by the content push platform, and performs presentation.

The implementation of each step has been given above, and is not described herein again.

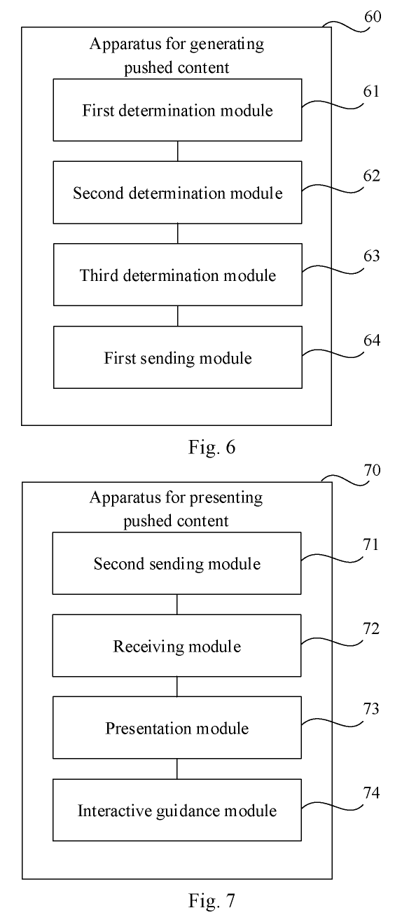

FIG. 6 is a block diagram of an apparatus for generating pushed content according to an implementation of the present disclosure. The apparatus for generating pushed content 60 may be applied to a content push platform. As shown in FIG. 6, the apparatus 60 includes:

a first determination module 61, configured to determine, in response to receiving a content acquisition request from a client, a user feature associated with the content acquisition request;

a second determination module 62, configured to determine, based on the user feature, a content material to be pushed;

a third determination module 63, configured to determine, based on the user feature, target style configuration information, a target virtual character animation, and target interaction configuration information, wherein the target interaction configuration information is used for configuring a target interaction component and a target interaction rule, and the target interaction component is used for being presented in association with the target virtual character animation; and

a first sending module 64, configured to send a pushed data package including the content material, the target style configuration information, the target virtual character animation, and the target interaction configuration information to the client, so that the client performs, based on the pushed data package, content presentation, and performs, based on the presented target interaction component and the target interaction rule, interactive guidance for a user of the client.

Optionally, the content material is associated with a target content identifier, and the target virtual character animation corresponds to a target character feature; and

the apparatus 60 further includes:

a first acquisition module, configured to acquire, in response to determining that the content material does not include audio information, a plurality of audios corresponding to the target content identifier from a preset audio database;

a fourth determination module, configured to determine, from the plurality of audios, a target audio matching a timbre of the target character feature; and

an addition module, configured to add the target audio to the pushed data package, so that the client plays the target audio during presentation of presenting the target virtual character animation.

Optionally, the plurality of audios corresponding to the target content identifier are generated by:

a second acquisition module, configured to acquire content description information corresponding to the target content identifier; and

a processing module, configured to perform, based on a plurality of preset timbres, text-to-audio processing on the content description information, to obtain an audio corresponding to each preset timbre.

Optionally, the target style configuration information is determined by:

a first acquisition sub-module, configured to acquire a plurality of pieces of style configuration information stored;

a first prediction sub-module, configured to predict, for each piece of the style configuration information, and based on the user feature, the content material, and the style configuration information, an interaction effect during presentation of the style configuration information, to obtain a first prediction result; and

a first determination sub-module, configured to determine, based on the first prediction result and a first interaction effect requirement, style configuration information with a highest matching degree with the first interaction effect requirement, as the target style configuration information.

Optionally, the target virtual character animation is determined by:

a second acquisition sub-module, configured to acquire a character feature corresponding to each of a plurality of virtual character animations stored;

a second prediction sub-module, configured to predict, for each of the virtual character animations, and based on the user feature, the content material, and the character feature corresponding to the virtual character animation, an interaction effect when the virtual character animation is presented, to obtain a second prediction result; and

a second determination sub-module, configured to determine, based on the second prediction result and a second interaction effect requirement, a virtual character animation with a highest matching degree with the second interaction effect requirement, as the target virtual character animation.

Optionally, the target interaction configuration information is determined by:

a third acquisition sub-module, configured to acquire a plurality of pieces of interaction configuration information stored, wherein each piece of the interaction configuration information includes attribute information of an interaction component and an interaction rule;

a third prediction sub-module, configured to predict, for each piece of the interaction configuration information, and based on the user feature, the content material, and the interaction configuration information, an interaction effect of the interaction configuration information, to obtain a third prediction result; and

a third determination sub-module, configured to determine, based on the third prediction result and a third interaction effect requirement, interaction configuration information with a highest matching degree with the third interaction effect requirement, as the target interaction configuration information.

Regarding the apparatuses in the above embodiments, the specific manner in which each module performs an operation has been described in detail in the embodiments relating to the method, and will not be detailed herein.

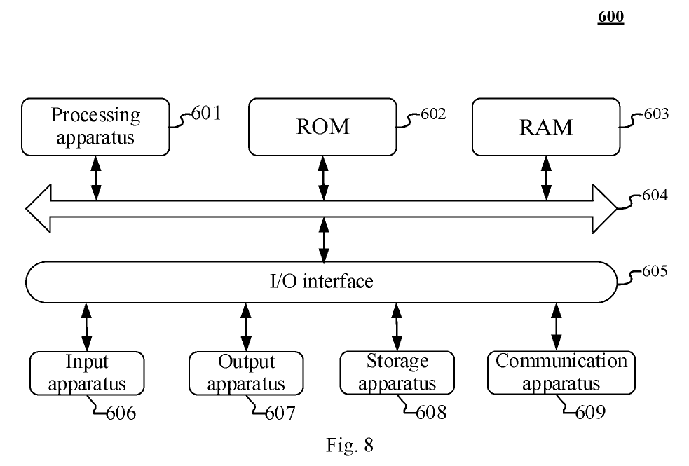

FIG. 7 is a block diagram of an apparatus for generating pushed content according to an implementation of the present disclosure. The apparatus for generating pushed content 70 may be applied to a client. As shown in FIG. 7, the apparatus 70 includes:

a second sending module 71, configured to send a content acquisition request to a content push platform;

a receiving module 72, configured to receive a pushed data package sent by the content push platform, wherein the pushed data package includes a content material, target style configuration information, a target virtual character animation, and target interaction configuration information, the target interaction configuration information is used for configuring a target interaction component and a target interaction rule, and the target interaction component is used for being presented in association with the target virtual character animation;

a presentation module 73, configured to present, based on the target style configuration information, the content material, the target virtual character animation, and the target interaction component; and

an interactive guidance module 74, configured to perform, based on the target interaction component and the target interaction rule, interactive guidance for a user of the client.

Regarding the apparatuses in the above embodiments, the specific manner in which each module performs an operation has been described in detail in the embodiments relating to the method, and will not be detailed herein.

Based on the same inventive concept, an embodiment of the present disclosure further provides a computer-readable medium having a computer program stored thereon, wherein the computer program, when executed by a processing apparatus, causes the processor to perform the steps of any method for generating pushed content or method for presenting pushed content described above.

Based on the same inventive concept, an embodiment of the present disclosure further provides an electronic device, the electronic device includes:

a memory, having a computer program stored thereon; and

a processor, configured to execute the computer program in the memory to perform the steps of any method for generating pushed content or method for presenting pushed content described above.

Based on the same inventive concept, an embodiment of the present disclosure further provides a computer program product including a computer program, wherein the computer program, when executed by a processor, causes the processor to perform the steps of any method for generating pushed content or method for presenting pushed content described above.

Reference is made to FIG. 8 below, which illustrates a schematic diagram of a structure of an electronic device 600 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer, a portable media player (PMP), and an in-vehicle terminal (such as an in-vehicle navigation terminal), and fixed terminals such as a digital TV and a desktop computer. The electronic device shown in FIG. 8 is merely an example, and should not impose any limitation on the function and scope of use of the embodiments of the present disclosure.

As shown in FIG. 8, the electronic device 600 may include a processing apparatus (such as a central processing unit and a graphics processing unit) 601, which may perform various appropriate actions and processing according to a program stored in a read-only memory (ROM) 602 or a program loaded from a storage apparatus 608 into a random access memory (RAM) 603. The RAM 603 also stores various programs and data required for the operation of the electronic device 600. The processing apparatus 601, the ROM 602, and the RAM 603 are connected to each other through a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; a storage apparatus 608 including, for example, a magnetic tape and a hard disk; and a communication apparatus 609. The communication apparatus 609 may allow the electronic device 600 to perform wireless or wired communication with other devices to exchange data. Although FIG. 8 shows the electronic device 600 having various apparatuses, it should be understood that it is not required to implement or provide all the apparatuses shown. More or fewer apparatuses may be implemented or provided alternatively.

In particular, according to the embodiments of the present disclosure, the processes described above with reference to the flowcharts may be implemented as computer software programs. For example, the embodiments of the present disclosure include a computer program product, which includes a computer program carried on a non-transitory computer-readable medium, wherein the computer program includes program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the functions defined in the method of the embodiments of the present disclosure are performed.

It should be noted that the computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, which may be used by or in combination with an instruction execution system, apparatus, or device. In the present disclosure, the computer-readable signal medium may include a data signal propagated on a baseband or as a part of a carrier, and computer-readable program code is carried therein. The data signal propagated in this way may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code included on the computer-readable medium may be transmitted in any suitable medium, including but not limited to a wire, an optical cable, a radio frequency (RF), or any suitable combination thereof.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be included in the electronic device, or may exist alone without being assembled into the electronic device.

The computer-readable medium carries one or more programs, the one or more programs, when executed by the electronic device, cause the electronic device to:

determine, in response to receiving a content acquisition request from a client, a user feature associated with the content acquisition request;

determine, based on the user feature, a content material to be pushed;

determine, based on the user feature, target style configuration information, a target virtual character animation, and target interaction configuration information, wherein the target interaction configuration information is used for configuring a target interaction component and a target interaction rule, and the target interaction component is used for being presented in association with the target virtual character animation; and

send a pushed data package including the content material, the target style configuration information, the target virtual character animation, and the target interaction configuration information to the client, so that the client performs, based on the pushed data package, content presentation, and performs, based on the presented target interaction component and the target interaction rule, interactive guidance for a user of the client.

Alternatively, the computer-readable medium carries one or more programs, which, when executed by the electronic device, cause the electronic device to:

send a content acquisition request to a content push platform;

receive a pushed data package sent by the content push platform, wherein the pushed data package includes a content material, target style configuration information, a target virtual character animation, and target interaction configuration information, the target interaction configuration information is used for configuring a target interaction component and a target interaction rule, and the target interaction component is used for being presented in association with the target virtual character animation;

present, based on the target style configuration information, the content material, the target virtual character animation, and the target interaction component; and

perform, based on the target interaction component and the target interaction rule, interactive guidance for a user of the client.

The computer program code for performing the operations of the present disclosure may be written in one or more programming languages or a combination thereof, wherein the programming languages include, but are not limited to, object-oriented programming languages such as Java, Smalltalk, and C++, and further include conventional procedural programming languages such as "C" language or similar programming languages. The program code may be executed entirely on a computer of a user, partially on the computer of the user, executed as an independent software package, executed partially on the computer of the user and partially on a remote computer, or executed entirely on the remote computer or a server. In the case of involving the remote computer, the remote computer may be connected to the computer of the user through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which includes one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that executes specified functions or operations, or may be implemented by a combination of dedicated hardware and computer instructions.

The modules involved in the embodiments of the present disclosure may be implemented in a software manner, and may also be implemented in a hardware manner. The name of a module does not constitute a limitation on the module itself under certain circumstances, and for example, the first determination module may also be described as "a module that determines a user feature associated with the content acquisition request".

The functions described above may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, a method for generating pushed content is provided, which is applied to a content push platform, wherein the method includes:

determining, in response to receiving a content acquisition request from a client, a user feature associated with the content acquisition request;

determining, based on the user feature, a content material to be pushed;

determining, based on the user feature, target style configuration information, a target virtual character animation, and target interaction configuration information, wherein the target interaction configuration information is used for configuring a target interaction component and a target interaction rule, and the target interaction component is used for being presented in association with the target virtual character animation; and

sending a pushed data package including the content material, the target style configuration information, the target virtual character animation, and the target interaction configuration information to the client, so that the client performs, based on the pushed data package, content presentation, and performs, based on the presented target interaction component and the target interaction rule, interactive guidance for a user of the client.

According to one or more embodiments of the present disclosure, a method for generating pushed content is provided, wherein the content material is associated with a target content identifier, and the target virtual character animation corresponds to a target character feature; and

the method further includes:

acquiring, in response to determining that the content material does not include audio information, a plurality of audios corresponding to the target content identifier from a preset audio database;

determining, from the plurality of audios, a target audio matching a timbre of the target character feature; and

adding the target audio to the pushed data package, so that the client plays the target audio during presentation of the target virtual character animation.

According to one or more embodiments of the present disclosure, a method for generating pushed content is provided, wherein the plurality of audios corresponding to the target content identifier are generated by:

acquiring content description information corresponding to the target content identifier; and

performing, based on a plurality of preset timbres, text-to-audio processing on the content description information, to obtain an audio corresponding to each preset timbre.

According to one or more embodiments of the present disclosure, a method for generating pushed content is provided, wherein the target style configuration information is determined by:

acquiring a plurality of pieces of style configuration information stored;

predicting, for each piece of the style configuration information, and based on the user feature, the content material, and the style configuration information, an interaction effect when the style configuration information is presented, to obtain a first prediction result; and

determining, based on the first prediction result and a first interaction effect requirement, style configuration information with a highest matching degree with the first interaction effect requirement, as the target style configuration information.

According to one or more embodiments of the present disclosure, a method for generating pushed content is provided, wherein the target virtual character animation is determined by:

acquiring a character feature corresponding to each of a plurality of virtual character animations stored;

predicting, for each of the virtual character animations, and based on the user feature, the content material, and the character feature corresponding to the virtual character animation, an interaction effect when the virtual character animation is presented, to obtain a second prediction result; and

determining, based on the second prediction result and a second interaction effect requirement, a virtual character animation with a highest matching degree with the second interaction effect requirement, as the target virtual character animation.

According to one or more embodiments of the present disclosure, a method for generating pushed content is provided, wherein the target interaction configuration information is determined by:

acquiring a plurality of pieces of interaction configuration information stored, wherein each piece of the interaction configuration information includes attribute information of an interaction component and an interaction rule;

predicting, for each piece of the interaction configuration information, and based on the user feature, the content material, and the interaction configuration information, an interaction effect of the interaction configuration information, to obtain a third prediction result; and

determining, based on the third prediction result and a third interaction effect requirement, interaction configuration information with a highest matching degree with the third interaction effect requirement, as the target interaction configuration information.

According to one or more embodiments of the present disclosure, a method for presenting pushed content is provided, which is applied to a client, wherein the method includes:

sending a content acquisition request to a content push platform;

receiving a pushed data package sent by the content push platform, wherein the pushed data package includes a content material, target style configuration information, a target virtual character animation, and target interaction configuration information, the target interaction configuration information is used for configuring a target interaction component and a target interaction rule, and the target interaction component is used for being presented in association with the target virtual character animation;

presenting, based on the target style configuration information, the content material, the target virtual character animation, and the target interaction component; and

performing, based on the target interaction component and the target interaction rule, interactive guidance for a user of the client.

According to one or more embodiments of the present disclosure, a pushed content generation apparatus is provided, which is applied to a content push platform, wherein the apparatus includes:

a first determination module, configured to determine, in response to receiving a content acquisition request from a client, a user feature associated with the content acquisition request;

a second determination module, configured to determine, based on the user feature, a content material to be pushed;

a third determination module, configured to determine, based on the user feature, target style configuration information, a target virtual character animation, and target interaction configuration information, wherein the target interaction configuration information is used for configuring a target interaction component and a target interaction rule, and the target interaction component is used for being presented in association with the target virtual character animation; and

a first sending module, configured to send a pushed data package including the content material, the target style configuration information, the target virtual character animation, and the target interaction configuration information to the client, so that the client performs, based on the pushed data package, content presentation, and performs based on the presented target interaction component and the target interaction rule, interactive guidance for a user of the client.

According to one or more embodiments of the present disclosure, an apparatus for generating pushed content is provided, which is applied to a client, wherein the apparatus includes:

a second sending module, configured to send a content acquisition request to a content push platform;

a receiving module, configured to receive a pushed data package sent by the content push platform, wherein the pushed data package includes a content material, target style configuration information, a target virtual character animation, and target interaction configuration information, the target interaction configuration information is used for configuring a target interaction component and a target interaction rule, and the target interaction component is used for being presented in association with the target virtual character animation;

a presentation module, configured to present, based on the target style configuration information, the content material, the target virtual character animation, and the target interaction component; and

an interactive guidance module, configured to perform, based on the target interaction component and the target interaction rule, interactive guidance for a user of the client.

According to one or more embodiments of the present disclosure, a computer-readable medium is provided, the computer-readable medium has a computer program stored thereon, wherein the computer program, when executed by a processor, causes the processor to perform the steps of any method for generating pushed content or method for presenting pushed content described above.

According to one or more embodiments of the present disclosure, an electronic device is provided, including:

a memory, having a computer program stored thereon; and

a processor, configured to execute the computer program in the memory to implement the steps of any method for generating pushed content or method for presenting pushed content described above.

According to one or more embodiments of the present disclosure, a computer program product is provided, including a computer program, wherein the computer program, when executed by a processor, implements the steps of any method for generating pushed content or method for presenting pushed content described above.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosure concept. For example, the above features and the technical features provided in the present disclosure (but not limited to) with similar functions are replaced each other to form a technical solution.

In addition, although the operations are depicted in a particular order, this should not be understood as requiring the operations to be performed in the particular order shown or in a sequential order. Under certain circumstances, multitasking and parallel processing may be advantageous. Similarly, although the above discussion includes several specific implementation details, these should not be construed as limiting the scope of the present disclosure. Certain features described in the context of separate embodiments may also be implemented in a single embodiment in combination. On the other hand, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are only exemplary forms of implementing the claims. Regarding the apparatuses in the above embodiments, the specific manner in which each module performs an operation has been described in detail in th e embodiments relating to the method, and will not be detailed herein.

I We claim:

1. A method for generating pushed content, applied to a content push platform, the method comprising:
determining, in response to receiving a content acquisition request from a client, a user feature associated with the content acquisition request;
determining, based on the user feature, a content material to be pushed;
determining, based on the user feature, target style configuration information, a target virtual character animation, and target interaction configuration information, the target interaction configuration information being used for configuring a target interaction component and a target interaction rule, and the target interaction component being used for being presented in association with the target virtual character animation; and
sending a pushed data package comprising the content material, the target style configuration information, the target virtual character animation, and the target interaction configuration information to the client, so that the client performs, based on the pushed data package, content presentation, and performs, based on the presented target interaction component and the target interaction rule, interactive guidance for a user of the client.

2. The method of claim 1, wherein the content material is associated with a target content identifier, and the target virtual character animation corresponds to a target character feature; and
the method further comprises:
acquiring, in response to determining that the content material does not comprise audio information, a plurality of audios corresponding to the target content identifier from a preset audio database;
determining, from the plurality of audios, a target audio matching a timbre of the target character feature; and
adding the target audio to the pushed data package, so that the client plays the target audio during presentation of the target virtual character animation.

3. The method of claim 2, wherein the plurality of audios corresponding to the target content identifier are generated by:
acquiring content description information corresponding to the target content identifier; and
performing, based on a plurality of preset timbres, text-to-audio processing on the content description information, to obtain an audio corresponding to each preset timbre.

4. The method of claim 1, wherein the target style configuration information is determined by:
acquiring a plurality of pieces of style configuration information stored;
predicting, for each piece of the style configuration information and based on the user feature, the content material, and the style configuration information, an interaction effect during presentation of the style configuration information, to obtain a first prediction result; and
determining, based on the first prediction result and a first interaction effect requirement, style configuration information with a highest matching degree with the first interaction effect requirement, as the target style configuration information.

5. The method of claim 4, wherein the style configuration information indicates specifying a presentation form of content, and indicates configuring a material, a button, a layout, an animation, and an interaction, to form an overall visual and auditory effect of the content.

6. The method of claim 1, wherein the target virtual character animation is determined by:
acquiring a character feature corresponding to each of a plurality of virtual character animations stored;
predicting, for each of the virtual character animations and based on the user feature, the content material, and the character feature corresponding to the virtual character animation, an interaction effect during presentation of the virtual character animation, to obtain a second prediction result; and
determining, based on the second prediction result and a second interaction effect requirement, a virtual character animation with a highest matching degree with the second interaction effect requirement, as the target virtual character animation.

7. The method of claim 6, wherein each of the virtual character animations is an animation based on a virtual character, and each of the virtual character animations is represented as that the virtual character makes a series of actions.

8. The method of claim 7, wherein the plurality of virtual character animations are stored in a virtual character database, and each of the virtual character animations is distinguished by a virtual character identifier.

9. The method of claim 1, wherein the target interaction configuration information is determined by:
acquiring a plurality of pieces of interaction configuration information stored, each piece of the interaction configuration information comprising attribute information of an interaction component and an interaction rule;
predicting, for each piece of the interaction configuration information and based on the user feature, the content material, and the interaction configuration information, an interaction effect of the interaction configuration information, to obtain a third prediction result; and
determining, based on the third prediction result and a third interaction effect requirement, interaction configuration information with a highest matching degree with the third interaction effect requirement, as the target interaction configuration information.

10. The method of claim 9, wherein the interaction configuration information indicates configuring an interaction component that needs to be presented in association with a virtual character animation, and indicates configuring a corresponding interaction rule, to provide an available interactive gameplay for the user in an interactive region formed by the virtual character animation and the interaction component.

11. A method for presenting pushed content, applied to a client, the method comprising:
sending a content acquisition request to a content push platform;
receiving a pushed data package sent by the content push platform, the pushed data package comprising a content material, target style configuration information, a target virtual character animation, and target interaction configuration information, the target interaction configuration information being used for configuring a target interaction component and a target interaction rule, and the target interaction component being used for being presented in association with the target virtual character animation;
presenting, based on the target style configuration information, the content material, the target virtual character animation, and the target interaction component; and
performing, based on the target interaction component and the target interaction rule, interactive guidance for a user of the client.

12. A non-transitory computer-readable medium, having a computer program stored thereon, wherein the computer program, when executed by a processor, causes the processor to:
determine, in response to receiving a content acquisition request from a client, a user feature associated with the content acquisition request;
determine, based on the user feature, a content material to be pushed;
determine, based on the user feature, target style configuration information, a target virtual character animation, and target interaction configuration information, the target interaction configuration information being used for configuring a target interaction component and a target interaction rule, and the target interaction component being used for being presented in association with the target virtual character animation; and
send a pushed data package comprising the content material, the target style configuration information, the target virtual character animation, and the target interaction configuration information to the client, so that the client performs, based on the pushed data package, content presentation, and performs, based on the presented target interaction component and the target interaction rule, interactive guidance for a user of the client.

13. The non-transitory computer-readable medium of claim 12, wherein the content material is associated with a target content identifier, and the target virtual character animation corresponds to a target character feature; and
wherein the computer program further causes the processor to:
acquire, in response to determining that the content material does not comprise audio information, a plurality of audios corresponding to the target content identifier from a preset audio database;
determine, from the plurality of audios, a target audio matching a timbre of the target character feature; and
add the target audio to the pushed data package, so that the client plays the target audio during presentation of the target virtual character animation.

14. The non-transitory computer-readable medium of claim 13, wherein the plurality of audios corresponding to the target content identifier are generated by:
acquiring content description information corresponding to the target content identifier; and
performing, based on a plurality of preset timbres, text-to-audio processing on the content description information, to obtain an audio corresponding to each preset timbre.

15. The non-transitory computer-readable medium of claim 12, wherein the target style configuration information is determined by:
acquiring a plurality of pieces of style configuration information stored;
predicting, for each piece of the style configuration information and based on the user feature, the content material, and the style configuration information, an interaction effect during presentation of the style configuration information, to obtain a first prediction result; and
determining, based on the first prediction result and a first interaction effect requirement, style configuration information with a highest matching degree with the first interaction effect requirement, as the target style configuration information.

16. The non-transitory computer-readable medium of claim 15, wherein the style configuration information indicates specifying a presentation form of content, and indicates configuring a material, a button, a layout, an animation, and an interaction, to form an overall visual and auditory effect of the content.

17. The non-transitory computer-readable medium of claim 12, wherein the target virtual character animation is determined by:
acquiring a character feature corresponding to each of a plurality of virtual character animations stored;
predicting, for each of the virtual character animations and based on the user feature, the content material, and the character feature corresponding to the virtual character animation, an interaction effect during presentation of the virtual character animation, to obtain a second prediction result; and
determining, based on the second prediction result and a second interaction effect requirement, a virtual character animation with a highest matching degree with the second interaction effect requirement, as the target virtual character animation.

18. The non-transitory computer-readable medium of claim 17, wherein each of the virtual character animations is an animation based on a virtual character, and each of the virtual character animations is represented as that the virtual character makes a series of actions.

19. The non-transitory computer-readable medium of claim 18, wherein the plurality of virtual character animations are stored in a virtual character database, and each of the virtual character animations is distinguished by a virtual character identifier.

20. The non-transitory computer-readable medium of claim 12, wherein the target interaction configuration information is determined by:
acquiring a plurality of pieces of interaction configuration information stored, each piece of the interaction configuration information comprising attribute information of an interaction component and an interaction rule;
predicting, for each piece of the interaction configuration information and based on the user feature, the content material, and the interaction configuration information, an interaction effect of the interaction configuration information, to obtain a third prediction result; and
determining, based on the third prediction result and a third interaction effect requirement, interaction configuration information with a highest matching degree with the third interaction effect requirement, as the target interaction configuration information.
